(19) United States
(12) Patent Application Publication
(10) Pub. No.: US 2017/0270591 A1
(43) Pub. Date: Sep. 21, 2017

(54) INFORMATION PROCESSING APPARATUS, INFORMATION PROCESSING METHOD, AND COMPUTER-READABLE MEDIUM

(71) Applicant: CASIO COMPUTER CO., LTD., Tokyo (JP)

(72) Inventor: Kunihiro MATSUBARA, Tokyo (JP)

(73) Assignee: CASIO COMPUTER CO., LTD., Tokyo (JP)

(21) Appl. No.: 15/391,171

(22) Filed: Dec. 27, 2016

(30) Foreign Application Priority Data
Mar. 16, 2016 (JP) 2016-051819

(51) Int. Cl. G06Q 30/06; G06F 17/30

(52) U.S. Cl. CPC G06Q 30/0631; G06F 17/30339

(57) ABSTRACT

An information processing apparatus includes the following. An obtaining unit obtains purchasing history information in a first region for a user. A controller derives an index showing a preference of the user based on the purchasing history information. The controller also generates purchase recommending information in a second region different from the first region for the user based on the index showing the preference of the user.

### BACKGROUND OF THE INVENTION

1. Field of the Invention

The present invention relates to an information processing apparatus, an information processing method and a computer-readable medium.

2. Description of the Related Art

Conventionally, a system which recommends items to a customer is known. For example, Japanese Patent Application Laid-Open Publication No. 2002-32453 describes a recommending system which stores in a database purchasing behavior history information when a customer purchases merchandise, extracts purchasing behavior history information of a customer similar to a customer who arrived, for example, with a similar age, and shows to the customer who arrived recommended merchandise information based on the extracted purchasing behavior information.

However, according to the recommending system as described in Japanese Patent Application Laid-Open Publication No. 2002-32453, since the merchandise is recommended according to age, etc. of the customer who entered, it may not be possible to recommend merchandise which suits the customer's preference.

### SUMMARY OF THE INVENTION

The purpose of the present invention is to provide purchase recommending information suitable for the user.

According to an aspect of the present invention, there is provided an information processing apparatus including: an obtaining unit which obtains purchasing history information in a first region for a user; and a controller which derives an index showing a preference of the user based on the purchasing history information and which generates purchase recommending information in a second region different from the first region for the user based on the index showing the preference of the user.

According to the present invention, purchase recommending information suitable for the user can be provided.

### BRIEF DESCRIPTION OF THE DRAWINGS

FIG. 1 is a diagram showing an entire configuration of a purchase recommending system according to the present embodiment.

FIG. 2 is a block diagram showing a functional configuration of a server apparatus shown in FIG. 1.

FIG. 3 is a diagram showing an example of data storage in user information storage.

FIG. 4 is a diagram showing an example of items in a user attribute index.

FIG. 5 is a diagram showing an example of data storage in purchasing history storage.

FIG. 6 is a diagram showing an example of data storage in attribute index derivation table storage.

FIG. 7 is a block diagram showing a functional configuration of a digital signage apparatus shown in FIG. 1.

FIG. 8 is a diagram showing a schematic configuration of a screen shown in FIG. 7.

FIG. 9 is a block diagram showing a functional configuration of a portable terminal shown in FIG. 1.

FIG. 10 is a flowchart showing purchasing history registration processing performed by the controller shown in FIG. 9.

FIG. 11 is a flowchart showing purchase recommending information output processing performed by the controller shown in FIG. 7.

FIG. 12 is a flowchart showing purchase recommending information generating processing performed by the controller shown in FIG. 2.

### DETAILED DESCRIPTION OF THE PREFERRED EMBODIMENTS

A preferred embodiment of the present invention is described in detail with reference to the attached drawings. An example applying an information processing apparatus of the present invention in a server apparatus 1 is described in the embodiment described below. The present invention is not limited to the illustrated examples.

### [Configuration of Purchase Recommending System 100]

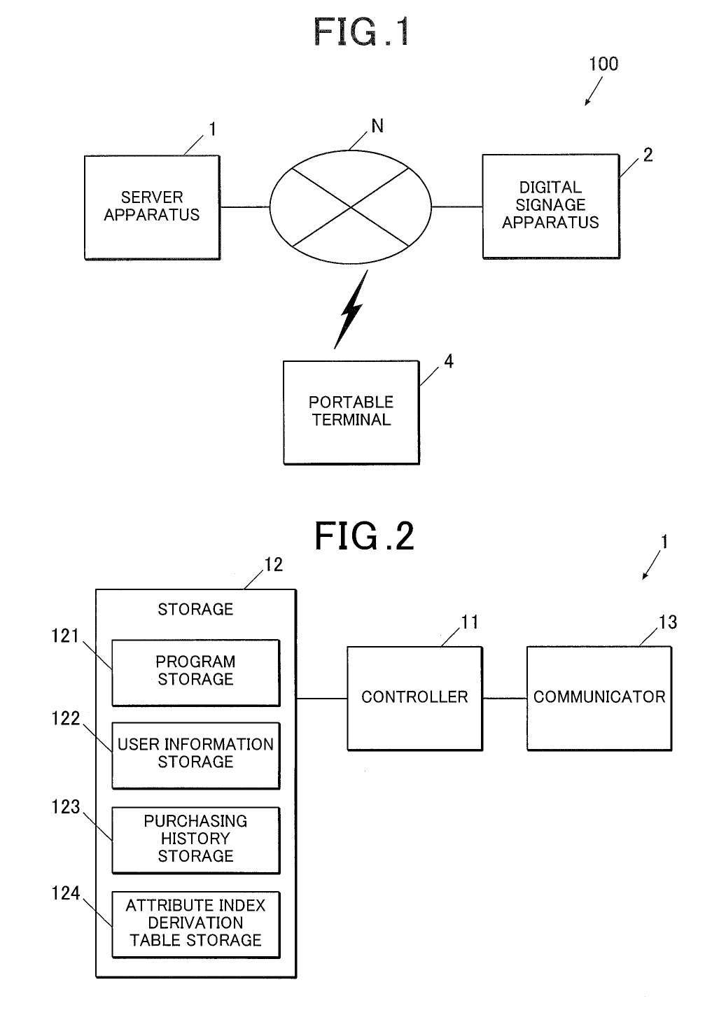

FIG. 1 is a diagram showing an entire configuration of a purchase recommending system 100 according to the present embodiment. As shown in FIG. 1, the purchase recommending system 100 includes a server apparatus 1, a digital signage apparatus 2, and a portable terminal 4. Communication is possible through a communication network N between the server apparatus 1 and the digital signage apparatus 2, and the server apparatus 1 and the portable terminal 4. The communication network N is a communication network including wired LAN (Local Area Network), wireless LAN, mobile communication network, the Internet, and the like. The number of digital signage apparatuses 2 and the number of portable terminals 4 are not limited.

[Configuration of Server Apparatus 1]

FIG. 2 is a block diagram showing a main control configuration of the server apparatus 1. The server apparatus 1 is an information processing apparatus which derives an index (hereinafter referred to as attribute index) showing a preference of a user based on purchasing history information of a user in a first region different from a second region (Japan in the present embodiment). The digital signage apparatus 2 is provided in the second region. Then, the server apparatus generates purchase recommending information in the second region for the user based on the derived attribute index. As shown in FIG. 2, the server apparatus 1 includes a controller 11, a storage 12, a communicator 13 and the like.

The controller 11 includes a CPU (Central Processing Unit) which executes various programs stored in a program storage 121 of the storage 12 to perform predetermined calculating and control of each unit and a memory which is to be a work area when the program is executed (not illustrated). In coordination with a program stored in the program storage 121 of the storage 12, the controller 11 performs a later-described purchase recommending generating processing.

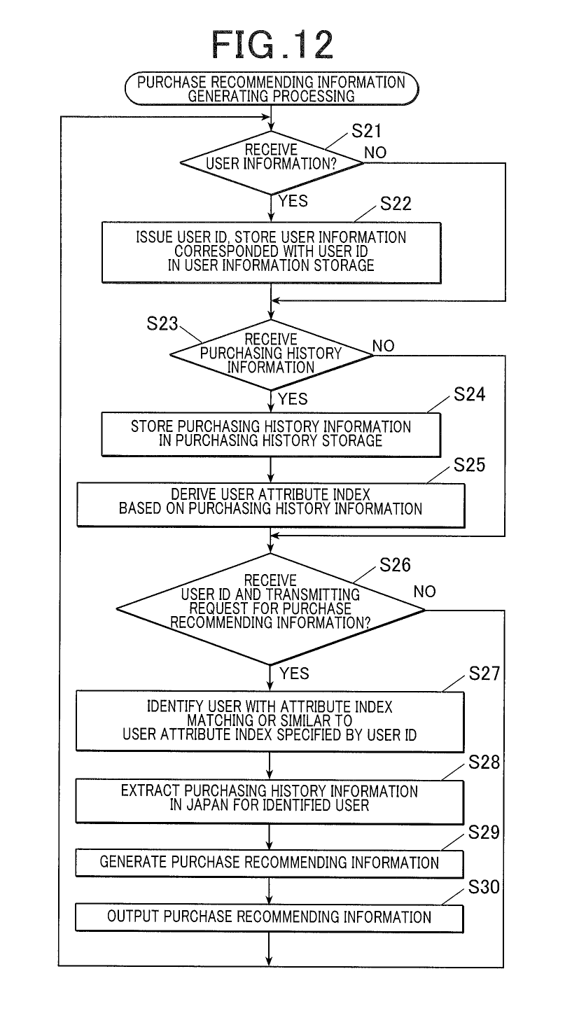

The storage 12 is composed of a HDD (Hard Disk Drive), a nonvolatile semiconductor memory or the like. As shown in FIG. 12, the storage 12 is provided with the program storage 121. The program storage 121 stores a system program executed by the controller 11, various processing programs, and data necessary to execute such programs.

The user information storage 122 is provided in the storage 12.

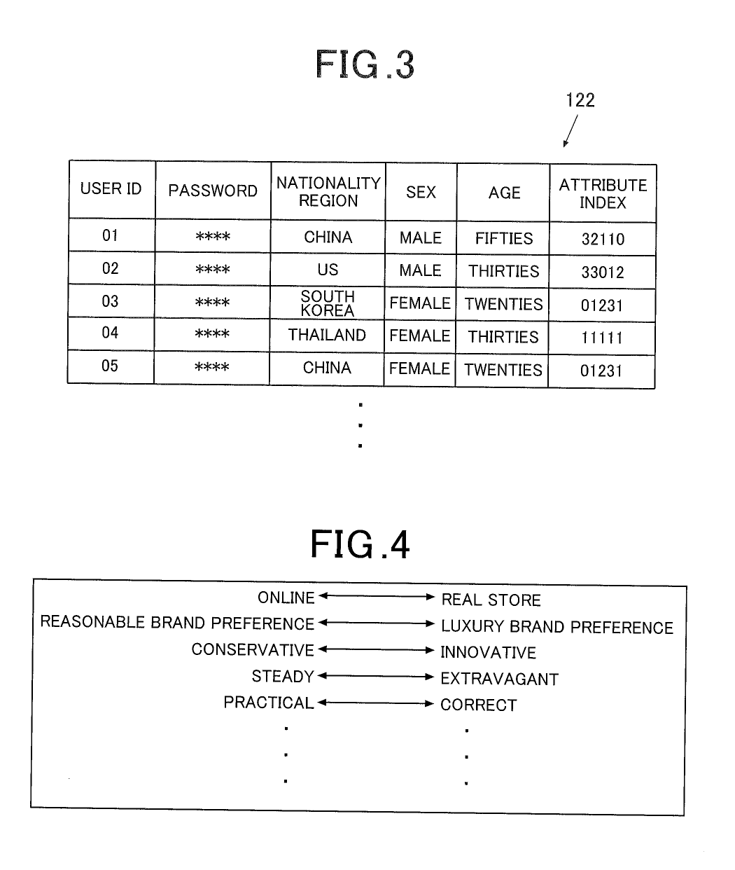

FIG. 3 shows a data storage example in the user information storage 122. As shown in FIG. 3, the user information storage 122 is provided with regions for items such as “user ID”, “password”, “nationality region”, “sex”, “age”, “attribute index”, and stores user information including the above items. The user information is transmitted from the portable terminal 4.

According to the present embodiment, the “attribute index” includes, for example, indexes for the plurality of items shown in FIG. 4 (index showing online purchase or real store purchase, index showing reasonable brand preference or luxury brand preference, index showing conservative or innovative, index showing steady or extravagant, index showing practical or correct). Based on the user purchasing history information, each item is evaluated on 4 levels of 0 to 3 (for example, as for each item shown in FIG. 4, when the preference on the left side of the arrow is strong, 0 and when the preference on the right side is strong, 3). The obtained evaluation value is aligned in a predetermined order as the index value (for example, aligned from the left side in order from the items at the top of FIG. 4). The contents and the number of the items in the attribute index are not limited to those shown in FIG. 4. For example, at least one of the items shown in FIG. 4 can be the attribute index, or other items can be included.

A purchasing history storage 123 is provided in the storage 12.

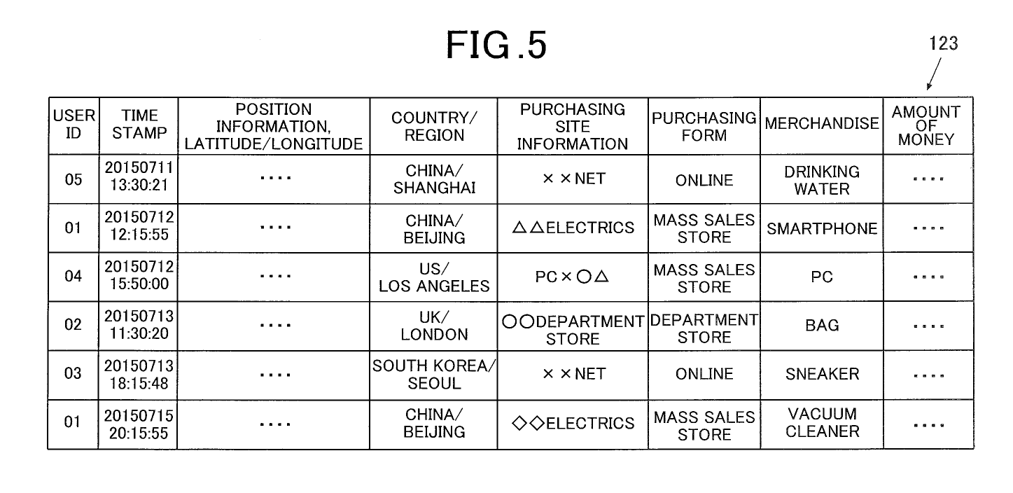

FIG. 5 shows an example of data storage in the purchasing history storage 123. As shown in FIG. 5, the purchasing history storage 123 is provided with regions such as “user ID”, “time stamp”, “position information (latitude/longitude)”, “country/region”, “purchasing site information”, “purchasing form”, “purchasing merchandise”, “amount of money” and the like. The purchasing history storage 123 stores the purchasing history information including the above items. The purchasing history information is transmitted from the portable terminal 4.

The storage 12 is provided with an attribute index derivation table storage 124 which stores the attribute index derivation table to derive the user attribute index.

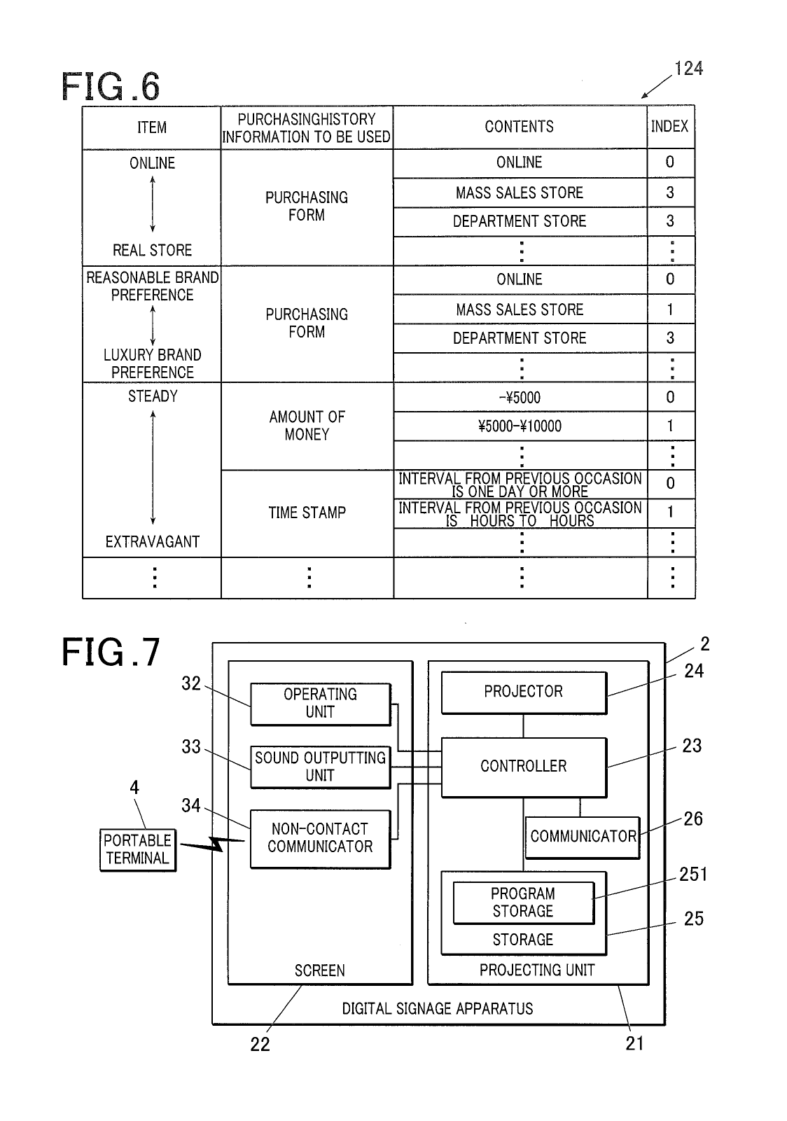

FIG. 6 shows a data storage example of the attribute index derivation table storage 124. As shown in FIG. 6, the attribute index derivation table storage 124 stores for each item of the attribute index, the item of the purchasing history information used to derive the index value of the item corresponded in advance with the index value according to the contents of the item of the purchasing history information. For example, in the item of online-real store, “purchasing form” is set as the purchasing history information used to derive the index value, and the index value 0 is stored corresponded with “online” in the “purchasing form”, and the index value 3 is stored corresponded with other contents (for example, “mass sales store”, “department store”, “private store”, etc.).

The contents of the attribute index derivation table storage 124 is not limited to the contents shown in FIG. 6. For example, the items in the purchasing history information used in deriving the index value of each item of the attribute index can be plural. The index value can be corresponded to the combination of contents in a plurality of items in the purchasing history information.

The communicator 13 includes a modem, a router, a network and the like, and performs communication with external devices connected to the communication network N. The communicator 13 functions as an obtaining unit.

### [Configuration of Digital Signage Apparatus 2]

FIG. 7 is a block diagram showing a main control configuration of the digital signage apparatus 2. The digital signage apparatus 2 reads the user ID from the portable terminal 4 and transmits the user ID to the server apparatus 1. Then, the digital signage apparatus 2 obtains the purchase recommending information corresponding to the user of the portable terminal 4 from the server apparatus 1 and outputs the purchase recommending information. According to the above-described embodiment, the digital signage apparatus 2 is provided in Japan as a second region and recommends purchased merchandise in Japan based on the user purchasing history in the first region.

As shown in FIG. 7, the digital signage apparatus 2 includes a projecting unit 21 which projects light of an image showing contents and a screen 22 which receives the light of the image projected from the projecting unit 21 on the back surface of the screen 22 and projects the image on the front surface.

First, the projecting unit 21 is described.

The projecting unit 21 includes a controller 23, a projector 24, a storage 25, and a communicator 26. The projector 24, the storage 25, and the communicator 26 are connected to the controller 23 as shown in FIG. 7.

The controller 23 includes a CPU which executes various programs stored in a program storage 251 of the storage 25 to perform predetermined calculating and to control various units, and a memory which is to be the work area when the programs are executed (both are not shown). In coordination with the program, the controller 23 performs purchase recommending information output processing shown in FIG. 11.

The projector 24 is a projecting device which converts image data output from the controller 23 to light of an image and projects the light to the screen 22. For example, the projector 24 may be a DLP (Digital Light Processing) (Registered Trademark) projector using DMD (digital micro-mirror device) which is a display element to form an optical image with reflected light by displaying on/off operation of each of a plurality of fine mirrors arranged in an array in a tilted angle at a high speed (XGA, horizontal 1024 pixels×vertical 768 pixels).

The storage 25 includes a HDD (Hard Disk Drive), a nonvolatile semiconductor memory, etc. As shown in FIG. 7, the storage 25 is provided with the program storage 251. The program storage 251 stores a system program executed by the controller 23, processing programs to perform various processing such as the purchase recommending information output processing shown in FIG. 11, and data necessary to execute these programs.

The communicator 26 includes a modem, a router, a network card, etc., and communicates with external devices connected to the communication network N.

Next, the screen 22 is described.

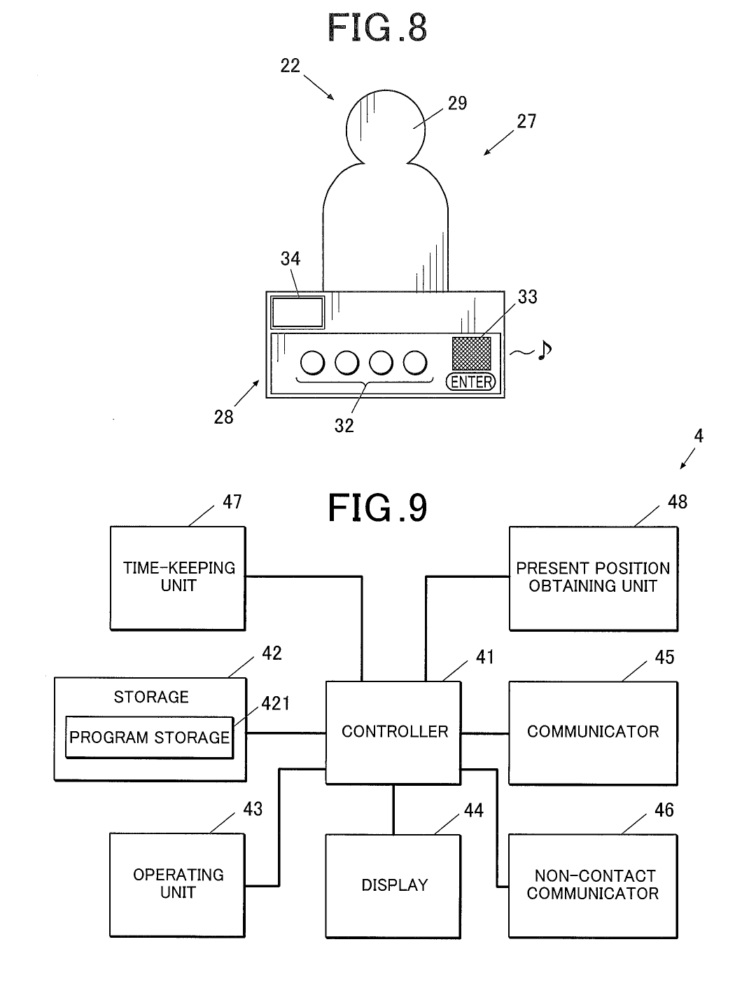

FIG. 8 is a front view showing a schematic configuration of the screen 22. As shown in FIG. 8, the screen 22 includes an image forming unit 27 and a pedestal 28 supporting the image forming unit 27.

The image forming unit 27 is a screen composed of the following. For example, one acrylic light transmitting plate 29 formed in a shape of a person is positioned so as to be substantially orthogonal to the emitting direction of the image light. A film screen for projecting the back surface with the film shaped Fresnel lens layered is attached to the light transmitting plate 29. With this, the screen is made. The display is composed of such image forming unit 27 and the above-described projector 24. The shape of the image forming unit 27 is in a shape of a person, but the shape is not limited to the above.

The pedestal 28 is provided with a button operating unit 32, a sound output unit 33 such as a speaker which outputs sound, and a non-contact communicator 34.

The operating unit 32 includes various functional buttons and detects the pressed signal of the operation button to be output to the controller 23.

The non-contact communicator 34 includes a wireless communication function by NFC (Near Field Communication) and performs non-contact communication with the portable terminal 4 corresponding to the NFC.

The operating unit 32, the sound output unit 33, and the non-contact communicator 34 are connected to the controller 23 as shown in FIG. 7.

### [Configuration of Portable Terminal 4]

FIG. 9 is a block diagram showing a main control configuration of the portable terminal 4. The portable terminal 4 is a terminal including a communication function such as a smartphone or cellular phone which the user holds, and as shown in FIG. 9, includes a controller 41, a storage 42, an operating unit 43, a display 44, a communicator 45, a non-contact communicator 46, a timekeeping unit 47, a present position obtaining unit 48, and the like.

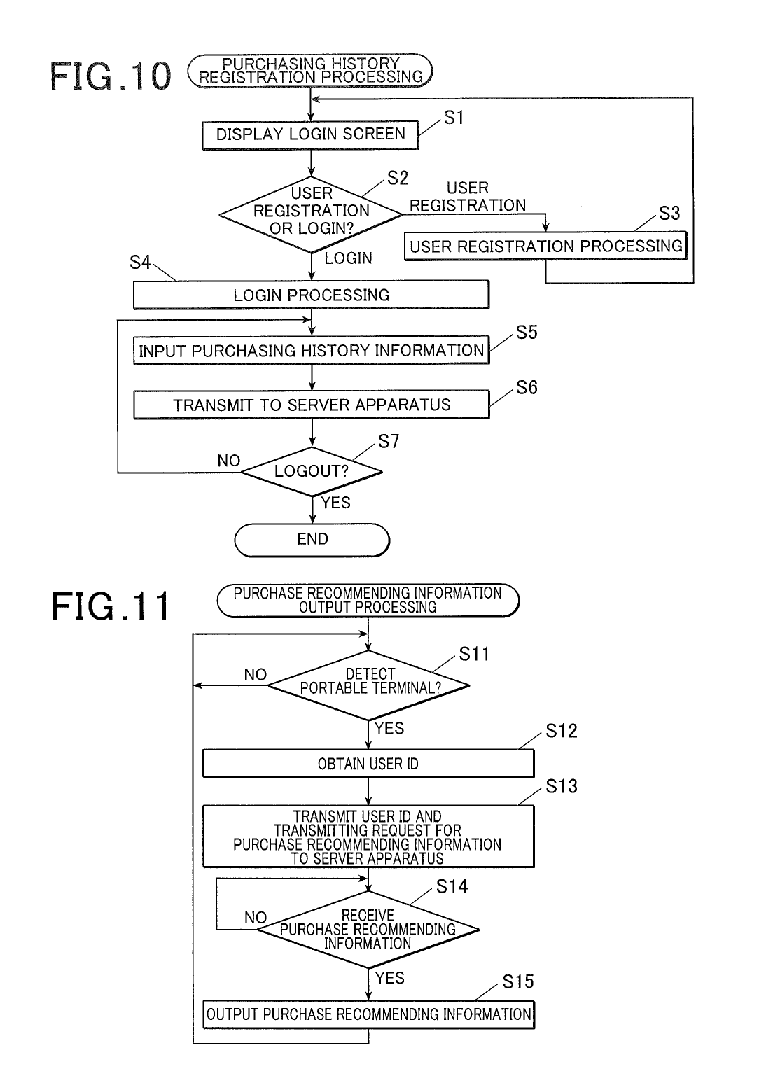

The controller 41 includes a CPU which executes various programs stored in a program storage 421 of the storage 42 to perform predetermined calculating and to control each unit and a memory which is to be a work area when the program is executed (both not shown). In coordination with the program stored in the program storage 421 of the storage 42, the controller 41 performs various processing such as purchasing history registration processing as shown in FIG. 10.

The storage 42 includes a nonvolatile semiconductor memory. The storage 42 is provided with the program storage 421 as shown in FIG. 9. The program storage 421 stores a system program executed by the controller 41, an application dedicated to the purchase recommending service (application program), other applications, and data necessary to execute the above program (for example, user ID (identification information in the purchase recommending system 100 for the user of the portable terminal 4), etc.).

The storage 42 stores map information.

The operating unit 43 includes various function keys, etc., receives input of the keys pressed by the user, and outputs the operation information to the controller 41. The operating unit 43 includes a touch panel in which transparent electrodes are positioned in a grid to cover the surface of the display 44, detects positions pressed by fingers or a touch pen, and outputs the position information to the controller 41 as the operation information.

The display 44 includes the LCD, etc., and performs various display such as waiting time on the screen according to the display control signal from the controller 41.

The communicator 45 connects to the communication network N wirelessly and communicates with the external apparatus connected to the communication network N.

The non-contact communicator 46 includes a wireless antenna and an NFC chip and performs non-contact communication with the device (NFC device) including the wireless communication function by NFC such as the digital signage apparatus 2, etc.

The timekeeping unit 47 includes a RTC (Real Time Clock), etc. to obtain the present date/time and outputs the above to the controller 41.

The present position obtaining unit 48 includes a GPS (Global Positioning System) receiving module, etc., to receive a radio wave from a positioning satellite, and to obtain the present position by performing various calculating processing. The above is output to the controller 41.

### [Operation of Purchase Recommending System 100]

Next, the operation of each apparatus included in the purchase recommending system 100 is described. The purchase recommending system 100 provides purchase recommending information for Japan (second region) based on the purchasing history information in a country in which the user lives (first region). Here, purchase recommending information is information regarding merchandise recommended to the user, for example, name, price, etc. of the recommended merchandise.

The user is able to register the purchasing history information in the first region with the application dedicated to the purchase recommending service of the portable terminal 4. When the user comes to Japan and holds the portable terminal 4 to the digital signage apparatus 2 provided in Japan (second region), the user is able to look at the purchase recommending information in Japan. The user is able to register the purchasing history information in Japan (second region) by the application dedicated to the purchase recommending service of the portable terminal 4.

### (Operation of Portable Terminal 4)

First, the operation of the portable terminal 4 is described.

FIG. 10 shows a flowchart of the purchasing history registration processing performed in the portable terminal 4. The purchasing history registration processing is performed by the controller 41 in coordination with the application stored in the program storage 421 when the application dedicated to the purchase recommending service is started.

The controller 41 displays a login screen on the display 44 (step S1). Although not illustrated, the login screen is a screen provided with an input space for the user ID and the password, a login instruction button, etc. The login screen is provided with a user registration button for new user registration, and by pressing the user registration button, the screen switches to the user registration screen.

When the pressing of the user registration button is detected by the operating unit 43 (step S2; user registration), the controller 41 performs user registration processing (step S3), and the processing returns to step S1.

In the user registration processing, the controller 41 displays the user registration screen on the display 44 and receives input of the user information. The user registration screen is a screen provided with, for example, input space for user information including the password, nationality region, sex, age, etc. and a transmitting button. When the user information is input with the operating unit 43 on the user registration screen and the transmitting button being pressed is detected, the controller 41 transmits the input user information to the server apparatus 1 by the communicator 45. When the user ID issued from the server apparatus 1 is received by the communicator 45, the controller 41 displays the user ID on the display 44 to notify the user ID to the user, and stores the user ID in the storage 42.

In the login screen, when the input of the login information (user ID and password) and the login instruction are detected by the operating unit 43 (step S2; login), the controller 41 performs the login processing (step S4).

In the login processing, the controller 41 transmits the input login information to the server apparatus 1 by the communicator 45, and makes a request to login to the server apparatus 1. When the login information is received by the communicator 13, the controller 11 of the server apparatus 1 checks the user information (user ID and password) stored in the user information storage 122. Then, when there is user information in the user information storage 122 in which the user ID and the password in the user information match with the received login information, the controller 11 allows login and transmits a login allowed notification to the portable terminal 4.

When the login processing ends, the controller 41 displays the purchasing history information registration screen on the display 44 and receives input of the purchasing history information with the operating unit 43 (step S5). The purchasing history information registration screen is a screen provided with a transmitting button and an input space for purchasing history information such as “country/region”, “position information (latitude/longitude)”, “purchasing site information”, “purchasing form”, “purchasing merchandise”, “amount of money”, etc. Here, “country/region” is information of the country and region where the purchase is made. “Position information (latitude/longitude)” is information of the latitude and the longitude of the purchasing site. “Purchasing site information” is information of the store where the merchandise is purchased. “Purchasing form” is information showing how the merchandise is purchased (for example, online, store (mass sales store, department store, supermarket, private store, etc.)).

The position information of the purchasing site can be directly input by the user, or for example, operation buttons such as “register present position”, “register from map”, etc. may be provided, and the position information of the purchasing site can be automatically obtained in response to pressing the operation button. For example, when the operating unit 43 detects that the “register present position” button is pressed, the controller 41 obtains the present position with the present position obtaining unit 48 and inputs the present position information as the position information. When the operating unit 43 detects that the “country/region”, “purchasing site information” are input and the “register from map” button is pressed, the controller 41 searches the map information stored in the storage 42 and obtains the position information of the input purchasing site.

When the operating unit 43 detects that the transmitting button is pressed, the controller 41 transmits the input purchasing history information with the user ID and the date/time information (time stamp) obtained from the timekeeping unit 47 added and transmits the above to the server apparatus 1 by the communicator 45 (step S6).

The controller 41 repeatedly performs the processing of steps S5 to S7, and when the operating unit 43 detects the instruction to logout (step S7; YES), the purchasing history registration processing ends.

### (Operation of Digital Signage Apparatus 2)

Next, the operation of the digital signage apparatus 2 is described.

FIG. 11 is a flowchart showing the purchase recommending information output processing performed in the digital signage apparatus 2. The purchase recommending information output processing is performed by the controller 23 in coordination with the program stored in the program storage 251 while the power of the digital signage apparatus 2 is ON.

First, the controller 23 waits until the non-contact communicator 34 detects the portable terminal 4 in the communicating area (step S11).

When the non-contact communicator 34 detects the portable terminal 4 in the communicating area (step S11; YES), the controller 23 obtains the user ID from the portable terminal 4 with the non-contact communicator 34 (step S12). Here, when the communication between the non-contact communicator 46 and the non-contact communicator 34 is established, the controller 41 of the portable terminal 4 reads the user ID stored in the storage 42 and transmits the user ID to the non-contact communicator 34 by the non-contact communicator 46.

Next, the controller 23 transmits the user ID and the transmitting request for the purchase recommending information to the server apparatus 1 by the communicator 26 (step S13), and waits for the purchase recommending information to be received from the server apparatus 1 by the communicator 26 (step S14).

When the purchase recommending information is received from the server apparatus 1 by the communicator 26 (step S14; YES), the controller 23 outputs the received purchase recommending information with the projector 24, the sound output unit 33, etc. (step S15), and the processing returns to step S11.

While the power of the digital signage apparatus 2 is ON, the controller 23 repeats the processing of steps S11 to S15.

The purchase recommending information is not limited, and can be a still picture or a moving picture, and sound can be attached to such images. The information is not limited to the information regarding the recommended merchandise, and can also include information of the store selling the recommended merchandise within a predetermined range from the present position.

### (Operation of Server Apparatus 1)

Next, the operation of the server apparatus 1 is described.

FIG. 12 shows the flowchart of the purchase recommending information generating processing performed in the server apparatus 1. When the power is turned ON, the purchase recommending information generating processing is performed by the controller 11 in coordination with the program stored in the program storage 121.

First, the controller 11 determines whether the user information is received from the portable terminal 4 by the communicator 13 (step S21).

When it is determined that the user information is not received from the portable terminal 4 by the communicator 13 (step S21; NO), the controller 11 advances the processing to step S23.

When it is determined that the user information is received from the portable terminal 4 by the communicator 13 (step S21; YES), the controller 11 issues the user ID and transmits the user ID to the portable terminal 4 by the communicator 13. The controller 11 also stores the received user information associated with the user ID in the user information storage 122 (step S22) and the processing advances to step S23.

In step S23, the controller 11 determines whether the purchasing history information is received from the portable terminal 4 by the communicator 13 (step S23).

When it is determined that the purchasing history information is not received from the portable terminal 4 by the communicator 13 (step S23; NO), the controller 11 advances the processing to step S26.

When it is determined that the purchasing history information is received from the portable terminal 4 by the communicator 13 (step S23; YES), the controller 11 stores the received purchasing history information in the purchasing history storage 123 (step S24). The controller 11 also derives the user attribute index based on the received purchasing history information (step S25). With this, the controller 11 advances the processing to step S26.

In step S25, the controller 11 first refers to the table stored in the attribute index derivation table storage 124 and derives the present index value for each item in the user attribute index from the received purchasing history information. As for the index value of the item of the attribute index derived using the plurality of items in the user attribute index, for example, the evaluation value for each item of the purchasing history information used is derived and the average (or the weighted average) is to be the present evaluation value. Next, the controller 11 searches the user information including the received user ID from the user information storage 122, and calculates the average (or, for example, a weighted average with the present value weighted larger) between the values of each item (each digit) in the “attribute index” and the presently derived evaluation value of each item. With this, the value of each item in the “attribute index” (value of each digit) is derived and updated.

In step S26, the controller 11 determines whether the user ID and the transmitting request for the purchase recommending information is received from the digital signage apparatus 2 by the communicator 13 (that is, whether the user ID and the transmitting request for the purchase recommending information is obtained) (step S26).

When it is determined that the user ID and the transmitting request for the purchase recommending information is not received from the digital signage apparatus 2 (step S26: NO), the controller 11 returns the processing to step S21.

When it is determined that the user ID and the transmitting request of the purchase recommending information are received from the digital signage apparatus 2 (step S26; YES), the controller 11 identifies a user with an attribute index which matches or is similar to the attribute index of the user specified by the received user ID and obtains the user ID (step S27). In step S27, the controller 11 extracts the user information corresponding to the received user ID from the user information storage 122 and obtains the “attribute index” of the extracted user information. Next, the controller 11 searches for the user information with the “attribute index” which matches with the obtained “attribute index” from the user information storage 122. When there is user information with a matching “attribute index” in the user information storage 122, the user ID of the user information is obtained. When there is no matching “attribute index”, for example, the user information with the “attribute index” having a degree of matching with the index value of each item or a certain item in the obtained “attribute index” equal to or higher than a predetermined reference is extracted, and the user ID is obtained.

Next, the controller 11 extracts the purchasing history information in Japan for the user with the obtained user ID (purchasing history information including Japan as the “country/region”) from the purchasing history storage 123 (step S28), and generates the purchase recommending information based on the extracted purchasing history information (step S29). For example, the controller 11 generates purchase recommending information recommending the “purchasing merchandise” in the extracted purchasing history information as the recommended merchandise. As described above, the purchase recommending information can be a stationary image or a moving image and sound may be attached to the image. Further, the position information of the digital signage apparatus 2 can be stored in the storage 12 corresponded with the identification information (for example, IP address, etc.) of the digital signage apparatus 2. Then, the purchasing history information which includes the same merchandise as the “purchasing merchandise” in the extracted purchasing history information and which includes the “position information” within a predetermined range from the digital signage apparatus 2 which performed the transmitting request for the purchase recommending information is extracted from the purchasing history storage 123, and the information guiding the position of the store as the purchasing site can be included in the purchase recommending information.

Then, the controller 11 transmits (outputs) the generated purchase recommending information to the digital signage apparatus 2 which is the transmitting source of the user ID by the communicator 13 (step S30), and the processing returns to step S21.

While the power of the server apparatus 1 is ON, the controller 11 repeats the processing of steps S21 to S30.

As described above, according to the purchase recommending system 100 of the present embodiment, when the server apparatus 1 obtains the purchasing history information in the first region from the portable terminal 4 by the communicator 13, the controller 11 derives the attribute index which is the index showing the preference of the purchases of the user based on the obtained purchasing history information and stores the attribute index in the user information storage 122. When the user ID and transmitting request for the purchase recommending information are received from the digital signage apparatus 2 provided in a second region, the controller 11 generates the purchase recommending information in the second region for the user who made the transmitting request based on the attribute index (stored in the user information storage 122) of the user corresponding to the received user ID and outputs the above to the digital signage apparatus 2.

Specifically, the server apparatus 1 includes purchasing history storage 123 which stores the purchasing history information, and user history storage 122 which stores the user attribute index corresponded with the user ID. When the transmitting request for the purchase recommending information is received by the communicator 13, another user with the attribute index which matches with or is similar to the attribute index of the user who requested the purchase recommending history is specified, and generates the purchase recommending information in the second region for the user who requested the purchase recommending information based on the purchasing history information of the specified another user who made a purchase in the second region.

Therefore, the purchase recommending information suitable for the user can be provided. Moreover, it is possible to provide purchase recommending information suitable for the user in the second region different from the first region in which the user usually makes purchases.

For example, the purchasing history information includes at least one of the purchasing price, the purchasing form and the information of the store of the purchasing site, and the controller 11 derives the user attribute index based on at least one of the purchasing price, the purchasing form, and the information of the store of the purchasing site included in the purchasing history information received from the portable terminal 4 by the communicator 13. Therefore, the preference in purchase for the user can be easily derived using at least one of the purchasing price, the purchasing form and the information of the store of the purchasing site.

The description for the above-described embodiment is one example of a preferable purchase recommending system according to the present invention, and the present invention is not limited to the above.

For example, according to the above-described embodiment, the second region is Japan, and the purchase recommending information in Japan is provided to the user, but the second region can be a country other than Japan.

According to the above-described embodiment, when the portable terminal 4 is held against the non-contact communicator 34 of the digital signage apparatus 2, the digital signage apparatus 2 obtains the user ID from the portable terminal 4, and the purchase recommending information is provided to the user. Alternatively, the digital signage apparatus 2 may obtain the user ID by input through operation of the operating unit 32, and the user ID does not have to be obtained using non-contact communication.

According to the above-described embodiment, the purchase recommending information is output by the digital signage apparatus 2, but the present invention is not limited to the above, and the purchase recommending information may be output by the portable terminal 4. In this case, for example, the information of the second region can be input by the operating unit 43. When the input second region information and user ID are transmitted from the portable terminal 4 to the server apparatus 1, the server apparatus 1 performs the processing of steps S27 to S30 to generate the purchase recommending information in the second region, and transmits the generated purchase recommending information to the portable terminal 4 by the communicator 26. Then, the portable terminal 4 displays (or outputs with sound) the received purchase recommending information on the display 44.

The other detailed configuration of the purchase recommending system and the units composing the system and the detailed operation of the above may be suitably changed without leaving the scope of the present invention.

Various embodiments of the present invention are described, but the scope of the present invention is not limited to the embodiments illustrated above. The scope of the present invention includes the attached claims and its equivalents.

This application is based upon and claims the benefit of priority from the prior Japanese Patent Application No. 2016-051819, filed Mar. 16, 2016, the entire contents of which are incorporated herein by reference.

What is claimed is:

1. An information processing apparatus comprising:
an obtaining unit which obtains purchasing history information in a first region for a user; and
a controller which derives an index showing a preference of the user based on the purchasing history information and which generates purchase recommending information in a second region different from the first region for the user based on the index showing the preference of the user.

2. The information processing apparatus of claim 1, further comprising,
a storage which stores the purchasing history information with the index showing the preference of the user corresponded with identification information of the user; and
a communicator which receives a request for purchase recommending information,
wherein,
the purchasing history information includes user identification information, purchasing merchandise and information of purchasing region; and
the controller specifies another user with the index which matches with or is similar to the index of the user who requested the purchase recommending information, and generates purchase recommending information in the second region for the user who requested the purchase recommending information based on the purchasing history information regarding a purchase made in the second region by the specified another user.

3. The information processing apparatus of claim 1, wherein,
the purchasing history information includes at least one of a purchasing price, a purchasing form, and information of a store of a purchasing site; and
the controller derives the index showing the preference of the user based on information of at least one of the purchasing price, the purchasing form, and the information of the store of the purchasing site included in the purchasing history information.

4. An information processing method comprising:
obtaining purchasing history information in a first region for a user;
deriving an index showing a preference of the user based on the purchasing history information; and
generating purchase recommending information in a second region different from the first region for the user based on the index showing the preference of the user.

5. A non-transitory computer-readable medium having a program stored thereon for controlling a computer to perform the following:
obtaining purchasing history information in a first region for a user;
deriving an index showing a preference of the user based on the purchasing history information; and
generating purchase recommending information in a second region different from the first region for the user based on the index showing the preference of the user.
